(19) United States
(12) Patent Application Publication
(10) Pub. No.: US 2011/0023428 A1
(43) Pub. Date: Feb. 3, 2011

(54) COMPACT FIBER BED MIST ELIMINATOR

(75) Inventors: Steven A. Ziebold, Waterloo, IL (US); Frederick L. Mueller, Herculaneum, MO (US); Mark Spence, O'Fallon, MO (US); Douglas E. Azwell, Maryland Heights, MO (US)

Correspondence Address: SENNIGER POWERS LLP, 100 NORTH BROADWAY, 17TH FLOOR, ST LOUIS, MO, 63102, US

(73) Assignee: MECS, INC., St. Louis, MO (US)

(21) Appl. No.: 12/543,901

(22) Filed: Aug. 19, 2009

Related U.S. Application Data
(60) Provisional application No. 61/109,447, filed on Oct. 29, 2008.

(51) Int. Cl. B01D 46/52

(52) U.S. Cl. 55/419

(57) ABSTRACT

A mist eliminator for use in removing aerosols and particularly liquids from a gas flow. The mist eliminator includes filter panels made of fiber material that arranged generally parallel to the inflow of gas into the mist eliminator. The construction of the mist eliminator controls gas velocities and provides sufficient aerosol removal in a compact volume at low operating pressure drop.

### REFERENCE TO RELATED APPLICATIONS

This application claims the benefit of U.S. Provisional Application Ser. No. 61/109,447, filed Oct. 29, 2008, the entire contents of which are incorporated herein by reference.

### GOVERNMENT LICENSE RIGHTS

The U.S. Government has a paid-up license in this invention and the right in limited circumstances to require the patent owner to license others on reasonable terms as provided for by the terms of U.S. Navy Prime Contract N00024-04-C-2118 awarded by the Department of Defense.

### FIELD OF THE INVENTION

This invention relates generally to mist eliminators and more particularly to a compact fiber bed mist eliminator having high removal efficiency and low pressure drop without re-entrainment.

### BACKGROUND OF THE INVENTION

Undesired liquid aerosol and/or particulate entrainment in a gas flow is a common problem that can be addressed by placing a fiber bed in the flow that is selected to capture the liquid or particulate while permitting the gas to flow through. Considerations in the filtering out of aerosols, entrained liquids and/or particulates include the efficacy of the fiber bed in removing the airborne entrained material, and the energy required to move the flow stream through the fiber bed to achieve separation. The energy consumed is reflected by the pressure drop across the fiber bed (i.e., between the upstream and downstream sides of the fiber bed). In addition to requiring energy, the back pressure may be highly detrimental to the operation of the machinery generating the flow stream. The smaller the area of the fiber bed the flow stream must be forced through, the more the pressure drop and hence the greater to back pressure to upstream equipment. Moreover, while a thicker fiber bed provides greater collection efficiencies, this will also produce a greater pressure drop. Thinner fiber beds can fail to provide adequate removal of aerosols from the flow stream, especially when the mass mean particle size is submicron.

### SUMMARY OF THE INVENTION

In one aspect of the present invention, a mist eliminator for use in separating aerosols from a gas flow generally comprises a container having an inlet at an inlet end of the container and an outlet at an outlet end of the container. Filter panels each include a fiber mat having fibrous filter material formed by fine fibers. The fiber mat has pleats extending lengthwise of the filter panels. The filter panels are disposed in the container so that the filter mats of adjacent filter panels are spaced apart. The filter panels define flow channels between adjacent filter panels and flow channels between filter panels and adjacent walls of the container. Some of the flow channels define inlet flow channels in fluid communication with the inlet and blocked at the outlet end of the container to prevent gas flow from exiting the inlet flow channel to the outlet and some of the flow channels define outlet flow channels in fluid communication with the outlet and blocked at the inlet end of the container to prevent gas flow entering the container through the inlet from entering the outlet flow channels. Thus, the gas flow enters the container, passes into the inlet flow channels and thence laterally with respect to the inlet flow direction through one of the filter panels into the outlet flow channels for passage to the outlet of the container.

In another aspect of the present invention, a mist eliminator for use in separating aerosols from a gas flow generally comprises a container as set forth in the preceding paragraph. Filter panels each include a pleated fiber mat having fibrous filter material. The filter panels are disposed in the container so that the filter mats of adjacent filter panels are spaced apart. The filter panels define flow channels. At least one of the flow channels defines an inlet flow channel in fluid communication with the inlet and blocked at the outlet end of the container to prevent gas flow from exiting the inlet flow channel to the outlet and at least one of the flow channels defines an outlet flow channel in fluid communication with the outlet and blocked at the inlet end of the container to prevent gas flow entering the container through the inlet from entering the outlet flow channel. Thus, the gas flow enters the container, passes laterally with respect to the inlet flow direction through at least one of the filter panels into the outlet flow channel for passage to the outlet of the container.

Other objects and features will be in part apparent and in part pointed out hereinafter.

### BRIEF DESCRIPTION OF THE DRAWINGS

FIG. 1 is a vertical section a fiber bed mist eliminator taken off center of the assembly and with a cap removed;

FIG. 2 is a side elevation of the fiber bed mist eliminator;

FIG. 3 is a section of the fiber bed mist eliminator taken in the plane including line 3-3 of FIG. 1;

FIG. 4 is an exploded schematic illustration of four fiber bed filter panels making up a fiber bed of the mist eliminator;

FIG. 5 is an enlarged, fragmentary section taken in the plane including line 5-5 of FIG. 4;

FIG. 6 is a perspective of a housing of the mist eliminator with portions broken away and an outlet end wall removed to show internal construction; and

FIG. 7 is a top plan view of the mist eliminator with the cap removed to show outlet openings.

Corresponding reference characters indicate corresponding parts throughout the several views of the drawings.

### DETAILED DESCRIPTION OF THE PREFERRED EMBODIMENTS

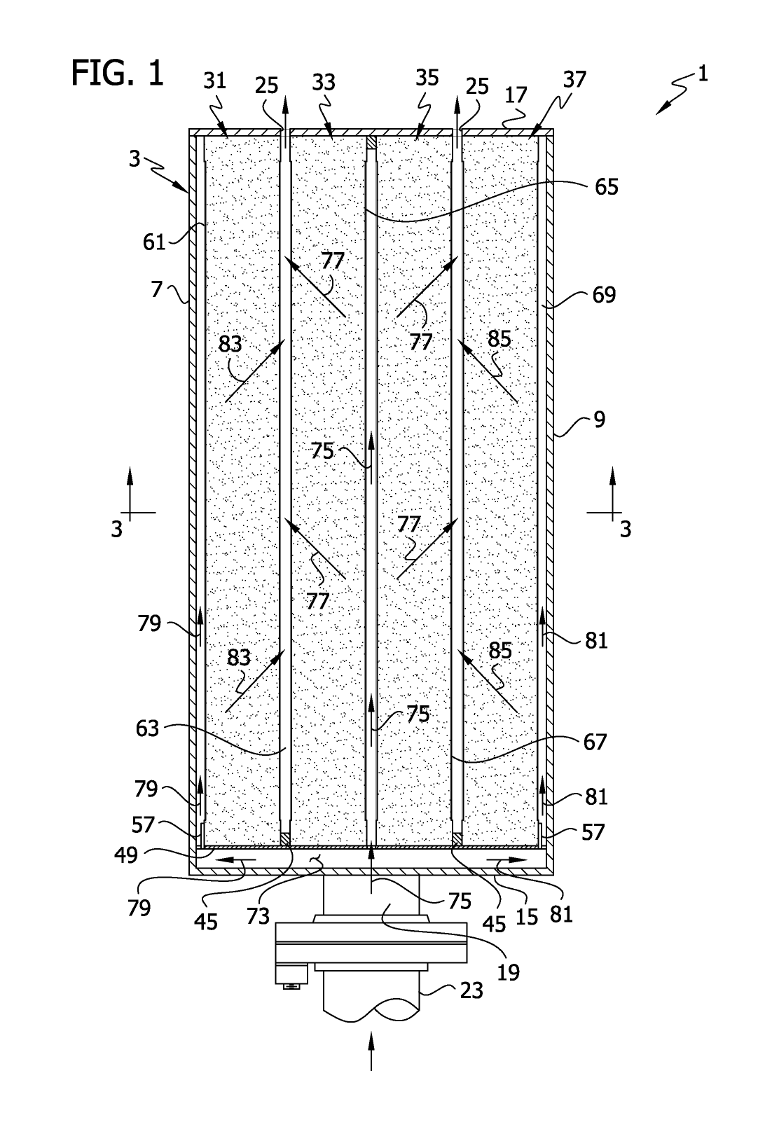

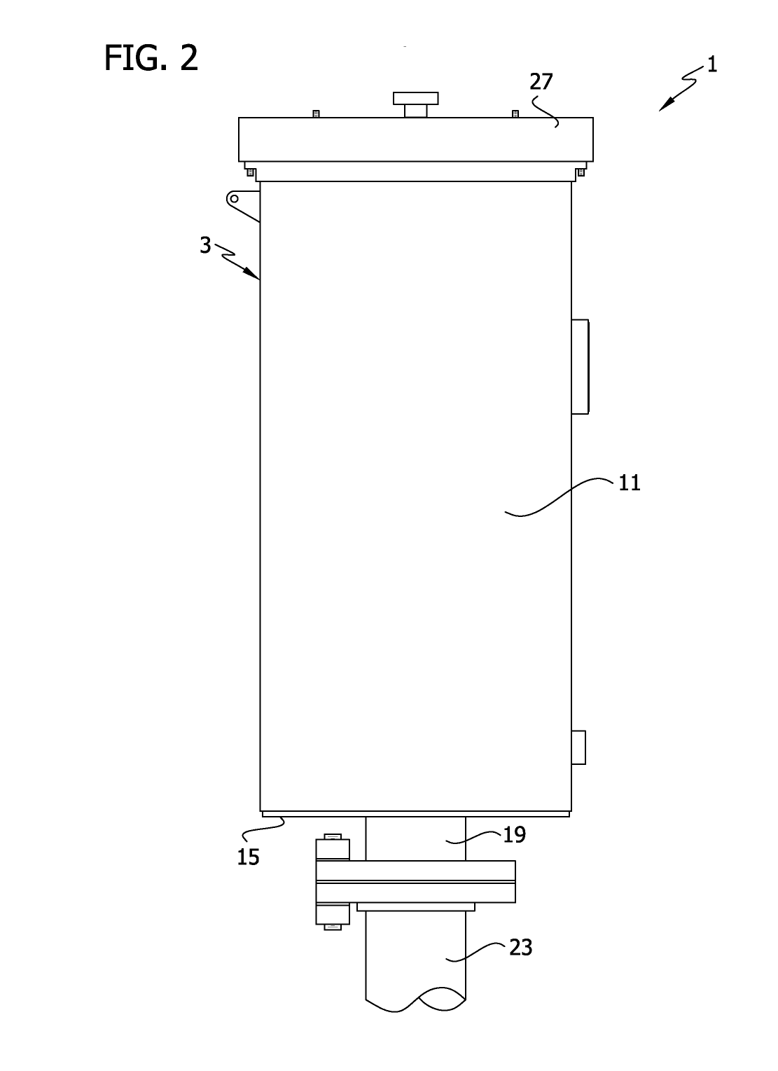

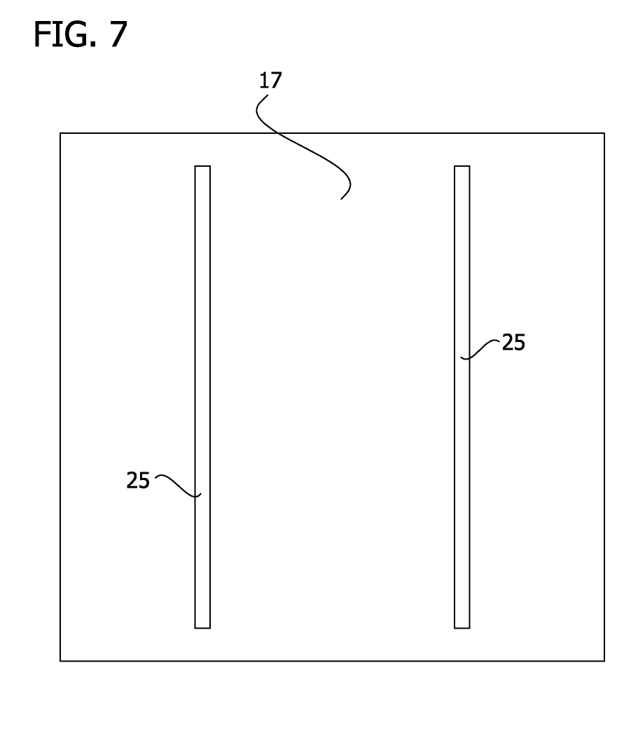

Referring now to the drawings and in particular to FIGS. 1, 2 and 6, a fiber bed mist eliminator of the present invention 1 is shown to comprise a housing 3 defining an interior space 5 having a rectangular cross section (the reference numbers designated their subjects generally). In one embodiment, the interior space 5 is relatively confined, having dimensions of 14 inches (36 cm) by 14 inches (36 cm) by 36 inches (91 cm). The housing 3 includes left and right side walls 7, 9, front and rear walls 11, 13, a bottom wall 15 and a top wall 17. The mist eliminator 1 will be described for convenience in terms of its orientation in FIGS. 1 and 2. It will be understood that other orientations may be used within the scope of the present invention. An inlet pipe 19 is in fluid communication with the interior space 5 of the housing 3 through an opening 21 in the bottom wall 15. The inlet pipe 19 is connected to an inflow pipe 23 extending from any machine or process (not shown) that produces a gas flow that contains liquid aerosol. For example, the inflow pipe 23 may carry outflow from an aeroderivative type turbine lube oil exhaust vent that entrains substantial turbine bearing lubricant (i.e., oil). The top wall 17 of the housing 3 includes a pair of slots 25 that form the outlet of the housing (see, FIGS. 1 and 7). A cap 27 covering (but spaced above) the top wall 17 helps to keep foreign matter out of the housing 3 and diffuses the outflow from the outlet slots 25 (see, FIG. 2). It will be appreciated that the housing may have other configurations without departing from the scope of the present invention. The size of the housing may be other than described, but it is noted that this present invention has particular application for use in spaces that are small in relation to the flow of gas that needs to be filtered.

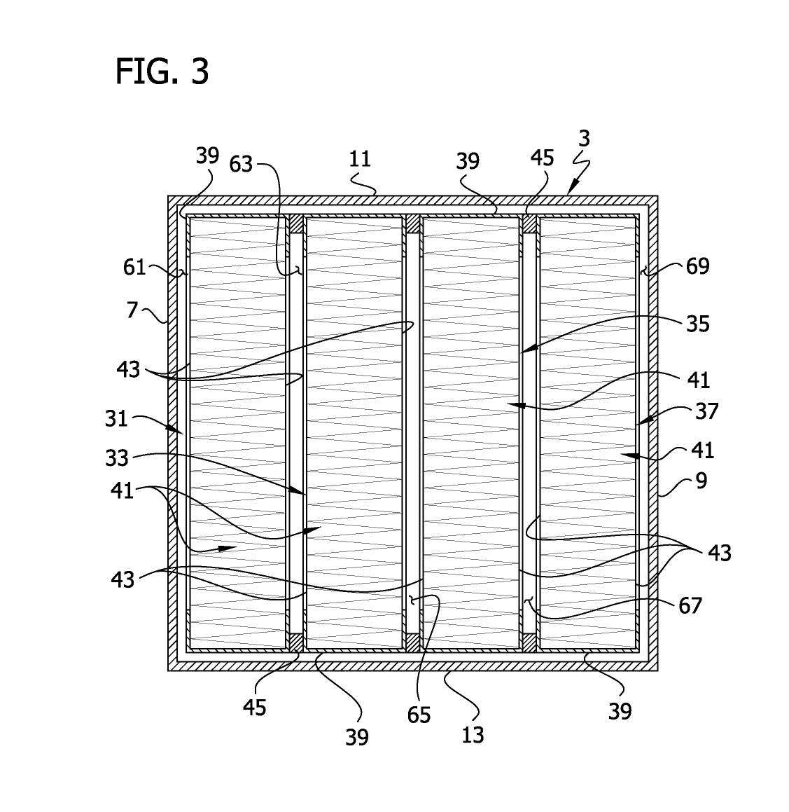

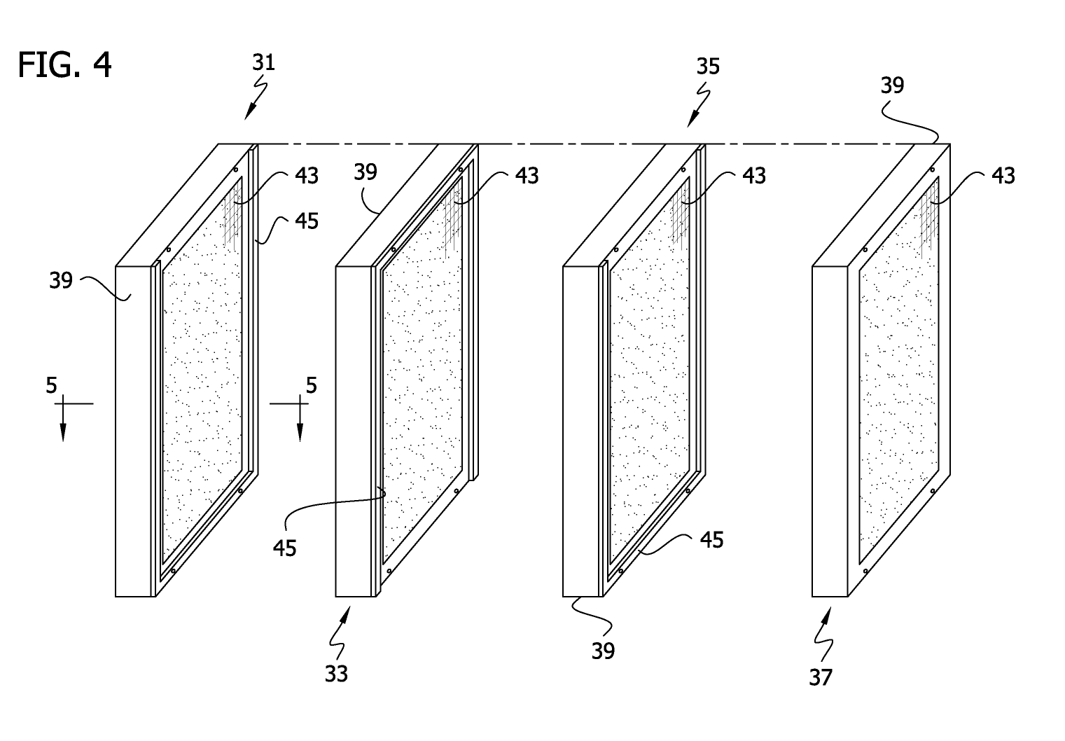

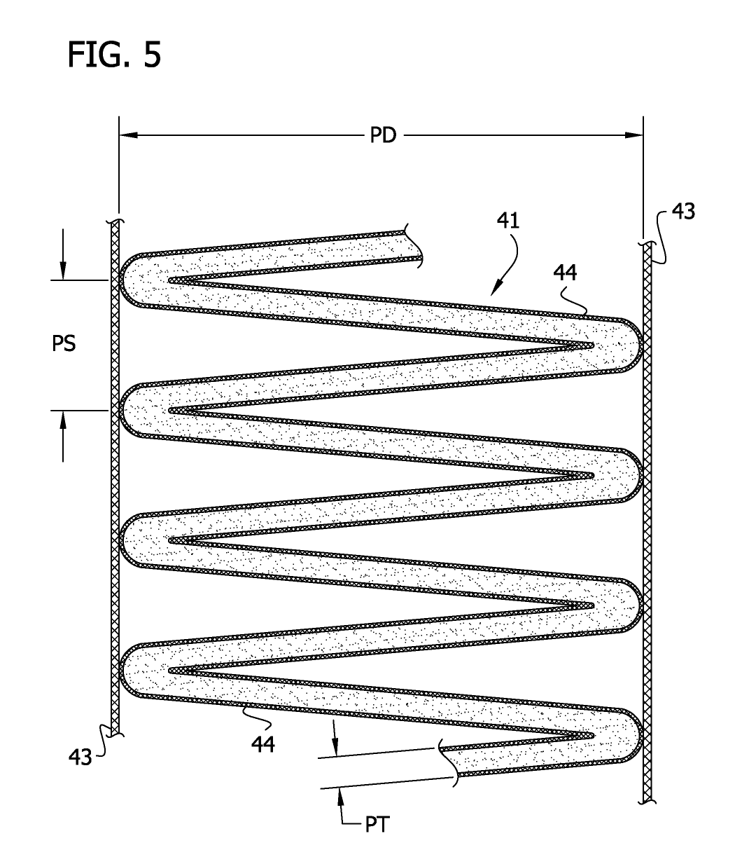

The housing 3 contains four filter panels (indicated generally at 31, 33, 35 and 37) each comprising a rectangular frame 39 supporting a pleated fiber mat 41 between opposite panel face screens 43 (see, FIG. 4). The panel face screens 43 in one embodiment are a stainless steel 18×18 mesh made of wire having a diameter of about 0.011 inches (0.28 mm) In the illustrated embodiment, the pleated fiber mat 41 comprises a fiber material compressed between support screens 44. The frames 39 comprise stainless steel channels and the pleated mat 41 is sealed to the channels with polyurethane or other suitable potting material (not shown). It will be understood that the number of filter panels may be other than four within the scope of the present invention. One face of the frame 39 of three of the filter panels (31, 33, 35) has a gasket 45 extending along three sides of the frame face. The fourth side is left open for reasons that will be explained more fully hereinafter. The pleated fiber mat 41 can be formed of a suitable fibrous material and have characteristics needed for the liquid load of the gas flow. For example, a suitable fiber mat can be one made from polymeric or glass fibers with suitable fiber binders and fiber treatment or finish. In one embodiment, the fiber mat 41 is LF-4½″ fiber mat available in the United States from Johns Manville of Denver, Colo. The LF-4½″ fiber mat is formed by fibers having a mean diameter of about 1 to 10 microns (0.04 to 0.4 thousandths of an inch) and more preferably between 1 and 5 microns (0.04 to 0.20 thousandths of an inch). The fiber mat has an uncompressed thickness of about one half inch (12.7 mm), a composite weight of about 0.40 oz/ft² (121.6 g/m²). In an air flow having a velocity of about 25 ft/min (0.13 m/s), the nominal pressure drop across the mat is about 0.45″wc (112 Pa). As incorporated into the filter panels 31-37, the fiber mat 41 has a compressed pleat thickness PT of about 0.1 to 0.53 inches (2.5 to 13 mm) and a compressed density of about 1 to 12 lbs/ft³(16 to 192 kg/m³). Preferably, the fibers are treated to be oleophobic or hydrophobic so that captured liquid (e.g., oil) blocks less area of the filter so that mist eliminator pressure drop and the total filtration volume necessary to achieve the desired efficiency are reduced. As best illustrated in FIGS. 3 and 5, the fiber mat 41 is pleated to increase the surface area available for mist capture. Surface area is maximized by variations of the pleat depth PD and pleat spacing PS. Pleat depth PD is preferably in the range of about 1 to 4 inches (2.5 to 10 cm) and more preferably about 2 to 3 inches. (5 to 7.5 cm). Pleat spacing PS is preferably in the range of about 0.5 to 3 pleats per inch (0.2 to 1.2 pleats per cm) and more preferably about 2 to 2.5 pleats per inch (0.75 to 1 pleats per cm). If the gas flow includes particulate or liquids that tend to clog the filter material (“plugging agents”), a coarser prefilter mat (not shown) can be incorporated on the upstream faces of the filter panels. Also, if mist loading of the incoming gas flow is high, a drainage layer (not shown) can be added to the downstream face of the central filter panel to inhibit re-entrainment of captured liquid. It is to be understood that filter panels may have other constructions within the scope of the present invention. For instance, the panel face screens 43 may be omitted.

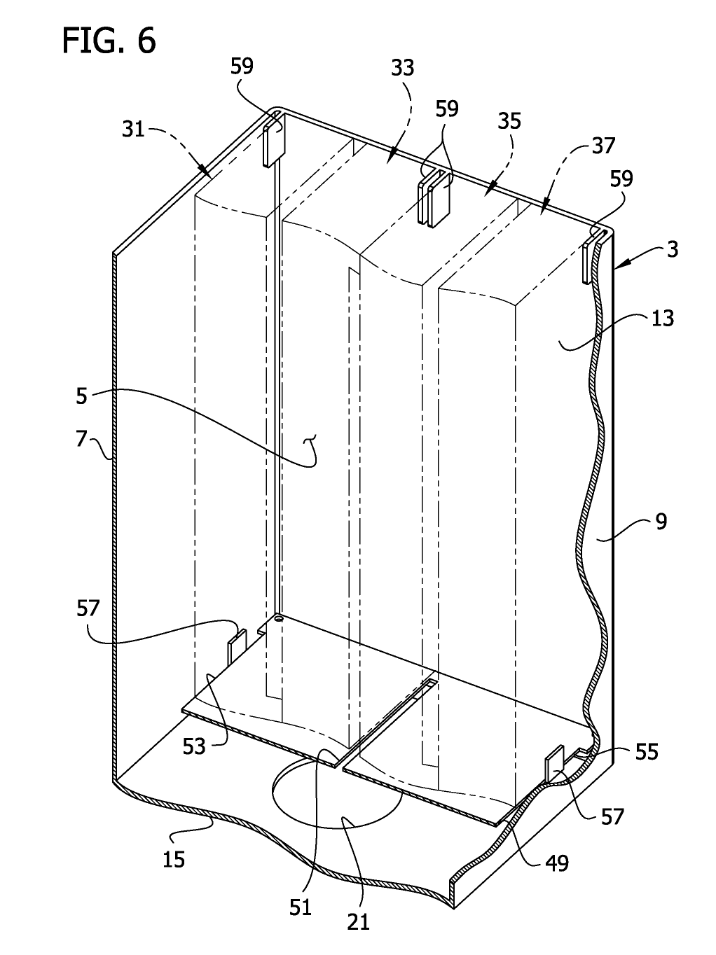

The interior of the housing 3 is constructed to mount the filter panels 31-37 in spaced relation from each other. The filter panels 31-37 are rectangular in shape and arranged so that their lengths extend along the height of the housing 3 (which is the greatest dimension of the housing). Referring to FIG. 6, the mist eliminator 1 further includes a standoff plate 49 in the housing 3 adjacent to the bottom wall 15, but spaced above the wall to allow the gas flow to enter the interior space 5 of the housing between the bottom wall and the standoff plate. The standoff plate 49 includes a central inlet slot 51 and two side recesses 53, 55. Flow to the filter panels 31-37 passes through either the central inlet slot 51 or side recesses 53, 55. The standoff plate 49 includes tabs 57 (only two are shown) and the housing 3 includes tabs 59 (only four of which are shown) that engage the filter panel frames 39 to space adjacent filter panels 31-37 from each other or to space the left and right filter panels 31, 37 from the left and right side walls 7, 9 of the housing (respectively). Fragmentary portions of the filter panels 31-37 are shown in phantom, and the standoff plate 49 has been partially broken away to show the inlet opening 21 in the bottom wall 15 in FIG. 6. Additional tabs (not shown) may be provided on the front wall 11 of the housing 3 and front of the standoff plate 49. The spacing causes the filter panels 31-37 to define five flow channels (designated 61, 63, 65, 67 and 69, respectively) between adjacent filter panels and between the outer two filter panels and the side walls of the housing 3.

The gasket 45 on the filter panel 35 (see, FIG. 4) engages the inside face of the frame 39 of the filter panel 37 on the right side of the housing 3. The gasket 45 helps to maintain spacing and seals with the inside face, and also helps to block entry of gas from the inlet opening 21 into the space between the right filter panel 37 and the central filter panel 35 immediately adjacent to the right filter panel. A sealant/adhesive such as polyurethane is applied to the gasket 45 and inside face of the frame 39 to form a robust seal. In addition, the frames 39 of both filter panels 35, 37 are both sealed using polyurethane or other suitable sealant to the top wall 17 inside the housing 3. In the illustrated embodiment, the filter panels 35, 37 are not sealed to the left, right, front and rear walls 7, 9, 11, 13 or to the standoff plate 49. Other suitable sealing arrangements to prevent gas bypassing may be used within the scope of the present invention. The recess 55 in the standoff plate 49 on the right side opens into the flow channel 69 defined between the right filter panel 37 and the right wall 13 of the housing 3. However, the flow channel 69 is blocked at its upper end by the sealed connection of the filter panel 37 with the top wall 17 of the housing 3. The two central filter panels 35, 33 are not sealed to each other at the bottom wall 15 and communicate with the inlet slot 51 in the standoff plate 49. However, the flow channel 65 between the central filter panels 33, 35 is blocked at its upper end by the sealed connection of the filter panels with the top wall 17. It will be appreciated that the filter panel 31 adjacent the left wall 7 and the central filter panel 33 adjacent to the left filter panel have the same configuration as the right filter panel 37 and the adjacent central filter panel 35 just described.

Gas flow entering the housing 3 into a plenum 73 between the bottom wall 15 and the standoff plate 49 pass is divided into three flow streams. One flow stream passes through the inlet slot 51 in the standoff plate 49 into the flow channel 65 between the central filter panels 33, 35, as indicated by arrows 75. As there is no exit from the flow channel 65 at the top wall 17, the gas flow stream is split and forced laterally as indicated by arrows 77 through the central filter panels 33, 35 which filter the aerosol (e.g., oil) from the gas flow, and into the flow channels 63, 67 in fluid communication with the outlet slots 25. The other two streams flow through the recesses 53, 55 in the standoff plate 49 between the left and right filter panels 31, 37 and the left and right walls 7, 9 (respectively) of the housing 3, as indicated by arrows 79 and 81. The streams 79, 81 entering the flow channels 61, 69 between the left and right filter panels 31, 37 and the corresponding left and right walls 7, 9 are similarly blocked by the sealed connections of the filter panels with the top plate 17. Gas is forced to flow inward through the fiber mats 41 of the filter panels 31, 37 as indicated by arrows 83, 85 so that the aerosol can be filtered. The lateral flows 83, 85 enter the flow channels 63, 67 connected to the outlet slots 25. The pleat velocity (i.e., the velocity of the fluid across the thickness of the fiber mat 41) is relatively low.

In one example, turbine lube oil bearing exhaust is routed by the inflow pipe 23 to the mist eliminator 1. In this example, the size of the housing 3 was 14 inches (36 cm) wide by 14 inches (36 cm) deep by 36 inches (91 cm) tall. The total exposed surface area of the fiber mats 41 of the filter panels 31, 33, 35, 37 available for aerosol collection was 154 ft² (14 m²). The pressure drop across the mist eliminator 1 was less than 0.5″ we (125 Pa) at a flow rate of about 50 ft³/min (0.02 m³/min) The removal efficiency of the mist eliminator 1 was 99.5%. based on inlet mist loading of about 500 mg/m³. It is anticipated that the emissions would be no more than about 1 to 2 ppmw turbine oil mist. More generally, the ratio of an area of the filter panels available to filter the gas flow to a volume of the container is preferably about 20 ft²/ft³ (66 m²/m³) to about 36 ft²/ft³ (118 m²/m³).

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up”, “down”, “inner”, “outer” and other orientational terms is made for convenience, but does not require any particular orientation of the components.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. A mist eliminator for use in separating aerosols from a gas flow, the mist eliminator comprising:
a container having an inlet at an inlet end of the container and an outlet at an outlet end of the container;
filter panels each including a fiber mat having fibrous filter material formed by fine fibers, the fiber mat having pleats extending lengthwise of the filter panels, the filter panels being disposed in the container so that the filter mats of adjacent filter panels are spaced apart, the filter panels defining flow channels between adjacent filter panels and flow channels between filter panels and adjacent walls of the container, some of the flow channels defining inlet flow channels in fluid communication with the inlet and blocked at the outlet end of the container to prevent gas flow from exiting the inlet flow channel to the outlet and some of the flow channels defining outlet flow channels in fluid communication with the outlet and blocked at the inlet end of the container to prevent gas flow entering the container through the inlet from entering the outlet flow channels whereby the gas flow enters the container, passes into the inlet flow channels and thence laterally with respect to the inlet flow direction through one of the filter panels into the outlet flow channels for passage to the outlet of the container.

2. A mist eliminator as set forth in claim 1 wherein the fibers forming the filter material have an average diameter of less than about 10 microns (0.4 thousandths of an inch).

3. A mist eliminator as set forth in claim 2 wherein a compressed pleat thickness of the filter material in the fiber panel is less than about 0.5 inches (13 mm).

4. A mist eliminator as set forth in claim 3 wherein the density of the compressed filter material is greater than or equal to about 1 lbs/ft³ (16 kg/m³).

5. A mist eliminator as set forth in claim 4 wherein the density of the compressed filter material is less than about 12 lbs/ft³ (192 kg/m³).

6. A mist eliminator as set forth in claim 3 wherein fibers in the fiber material are at least one of oleophobic and hydrophobic.

7. A mist eliminator as set forth in claim 1 wherein each filter panel comprises a rigid peripheral frame mounting the fiber mat.

8. A mist eliminator as set forth in claim 7 wherein each filter panel further comprises panel face screens mounted on the frame, the filter material being disposed between the screens.

9. A mist eliminator as set forth in claim 1 wherein the ratio of an area of the filter panels available to filter the gas flow to a volume of the container is at least about 20 ft²/ft³ (66 m²/m³) to about 36 ft²/ft³ (118 m²/m³).

10. A mist eliminator asset forth in claim 1 further comprising a standoff plate in the container spaced from the inlet of the container to define a plenum in fluid communication with the inlet flow channels.

11. A mist eliminator as set forth in claim 10 wherein the filter panels are free from sealing connection with the standoff plate and to the container to prevent flow through the container from the inlet to the outlet except through the inlet and outlet flow channels.

12. A mist eliminator as set forth in claim 1 wherein at least one of the inlet flow channels is defined between a wall of the container and one of the filter panels.

13. A mist eliminator as set forth in claim 1 wherein the depth of each pleat of the filter panel is at least about 1 inch (2.54 cm).

14. A mist eliminator as set forth in claim 1 wherein the density of pleats is about 1 to 3 pleats per inch (0.2 to 1.2 pleats per cm).

15. A mist eliminator as set forth in claim 1 wherein the fiber mat further comprises support screens receiving the fiber material between them and holding the fiber material in a compressed configuration.

16. A mist eliminator as set forth in claim 1 wherein at least some of the filter panels include a gasket sealingly contacting and spacing an adjacent other one of the filter panels.

17. A mist eliminator as set forth in claim 16 wherein the gasket has a generally U-shape and extends around three of four sides of the filter panel.

18. A mist eliminator for use in separating aerosols from a gas flow, the mist eliminator comprising:
a container having an inlet at an inlet end of the container and an outlet at an outlet end of the container;
filter panels each including a fiber mat having fibrous filter material, the fiber mat having pleats, the filter panels being disposed in the container so that the filter mats of adjacent filter panels are spaced apart, the filter panels defining flow channels, at least one of the flow channels defining an inlet flow channel in fluid communication with the inlet and blocked at the outlet end of the container to prevent gas flow from exiting the inlet flow channel to the outlet and at least one of the flow channels defining an outlet flow channel in fluid communication with the outlet and blocked at the inlet end of the container to prevent gas flow entering the container through the inlet from entering the outlet flow channel whereby the gas flow enters the container, passes laterally with respect to the inlet flow direction through at least one of the filter panels into an outlet flow channel for passage to the outlet of the container.
